(19) United States
(12) Patent Application Publication
(10) Pub. No.: US 2009/0066144 A1
(43) Pub. Date: Mar. 12, 2009

(54) Device for fastening a car seat

(76) Inventor: Anthony Fillie, Waterbury, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/899,678

(22) Filed: Sep. 7, 2007

(51) Int. Cl. B60R 22/10

(52) U.S. Cl. 297/463.1

(57) ABSTRACT

A seatbelt guide for use in a child's car seat having a handle end and an engagement end with an extending length portion disposed between. The engagement end is effective for grasping a tab end of a seatbelt in a vehicle. The extending length portion is sized to be threaded through slots of a child's car seat. The seatbelt guide engages the seatbelt of a vehicle and can be guided through the slots of a child's car seat, and attached to a buckle end of a seatbelt.

### BACKGROUND

(1) Field

The present application generally relates to a device for fastening a child's car seat. In particular, the present application is directed to a threading device that engages the buckle end of a seat belt and pulls the seatbelt through the slots of a child's car seat.

(2) Description of Related Art

Children's car seats must be securely fastened into a vehicle using the vehicle's standard seatbelt. Typically, the car seat has two small slots in the back that the vehicle's seatbelt is threaded through to secure the car seat in the car. The space between the back of the car seat and the seat of the car is very small and can make it extremely difficult to maneuver the seat belt through the slots.

It is crucially important for a child's car seat to be properly installed and secured in a vehicle to ensure that the car seat works properly and protects the child. Because of the difficulty of threading the seatbelt though the slots, some car seats are not properly secured. This can lead to child injuries or death.

### BRIEF SUMMARY

One aspect of the present application is a seatbelt guide for use in a child's car seat having a handle end and an opposing engaging end with an extending length portion between the handle end and the engaging end, the engaging end being effective to grasp a tab end of a seatbelt, and where the extending length portion is sized to be threaded through slots of a child's car seat.

Another aspect of the present application is a method for fastening a child's car seat into a car having a standard seatbelt with a buckle end and a tab end, including the steps of providing a seatbelt guide where an engaging end is effective to grasp the tab end of the seatbelt; pushing the seatbelt guide through seatbelt slots in the rear of the car seat; engaging the engaging end of the seatbelt guide with the tab end of the seatbelt; pulling the seatbelt guide through the seatbelt slots thereby threading the seatbelt through the seatbelt slots; releasing the buckle end of the seatbelt guide from the tab end of the seatbelt; and attaching the tab end of the seatbelt with the buckle end of the seatbelt that is installed in a vehicle.

### BRIEF DESCRIPTION OF THE DRAWINGS

For the purpose of illustrating the present application, the drawings show a form that is presently preferred. However, it should be understood that the present application is not limited to the precise arrangements and instrumentalities shown in the drawings, wherein:

FIG. 1 is a top view of a seatbelt guide according to the present application;

FIG. 2 is an isometric view of a seatbelt guide is use according to the present application; and

FIG. 3 is a top view of a seatbelt guide engaged with a seatbelt according to the present application.

### DETAILED DESCRIPTION

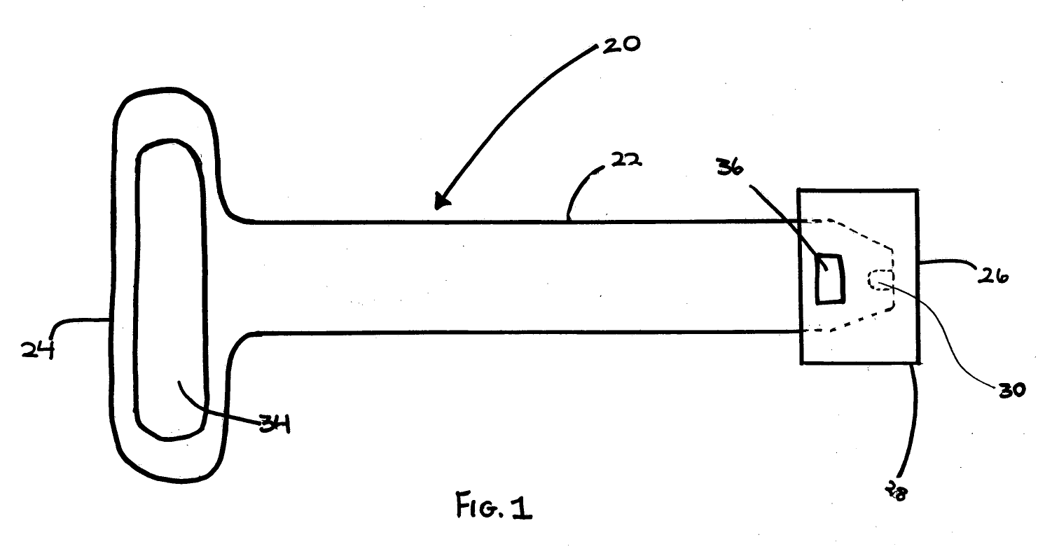

Referring now to the drawings in which like reference numerals indicate like parts, and in particular, to FIG. 1, one aspect of the present application is a seatbelt guide 20 having an extending length portion 22 with a handle end 24 and an engagement end 26. In use, seatbelt guide 20 helps thread a standard seatbelt (not shown) through slots of a child's car seat to secure it to the car seatbelt.

Handle end 24 and engagement end 26 are opposing one another. Extending length portion 22 is disposed between handle end 24 and engagement end 26. Seatbelt guide 20 has a length effective to reach behind a car seat and grasp a tab end of a seatbelt in a vehicle. In one embodiment, seatbelt guide 20 has an approximate length of about 22 to 26 inches. Seatbelt guide 20 has a width and thickness effective to slide through the slots in a child's car seat. In one embodiment, seatbelt guide 20 has a width of about 1 to 3 inches and a thickness of about 0.25 to 0.5 inches. Seatbelt guide 20 needs to be made of a material that has strength and flexibility. One suitable material is plastic. Seatbelt guide 20 can be manufactured in a variety of colors or patterns. For example, seatbelt guide 20 can be designed to match the interior of a vehicle or a car seat.

Handle end 24 of extending length portion 22 is adapted to be held by a user. In one embodiment, as shown in FIG. 1, handle end 24 has an opening 34 configured to be held by a user. Opening 34 can be sized to allow a user's hand to grip handle end 24. Handle end 24 can be any type of grip to aid in the comfort of the user.

As shown in FIG. 1, on engagement end 26 of extending length portion 22, there is a buckle 28 effective for engaging a tab end 38 of a seatbelt 40. Buckle 28 can be a traditional buckle that is found in a vehicle and can be adapted for any type of seatbelt manufactured. Typically, buckle 28 has a spring loaded piece 30 inside its casing that engages a hole 32 in tab end 38 of seatbelt 40 and locks the tab end into the buckle. Seatbelt 40 can be released by pressing a button 36 that applies pressure to spring loaded piece 30, thereby holding the spring loaded piece down and allowing tab end 38 to be released.

Buckle 28 can be secured to extending length portion 22 by any means. In one embodiment, buckle end 28 can be constructed of plastic and seatbelt guide 20 can be constructed of one solid piece. In another embodiment of the present application, buckle end 28 can be a manual buckle like that on an airplane. (not shown)

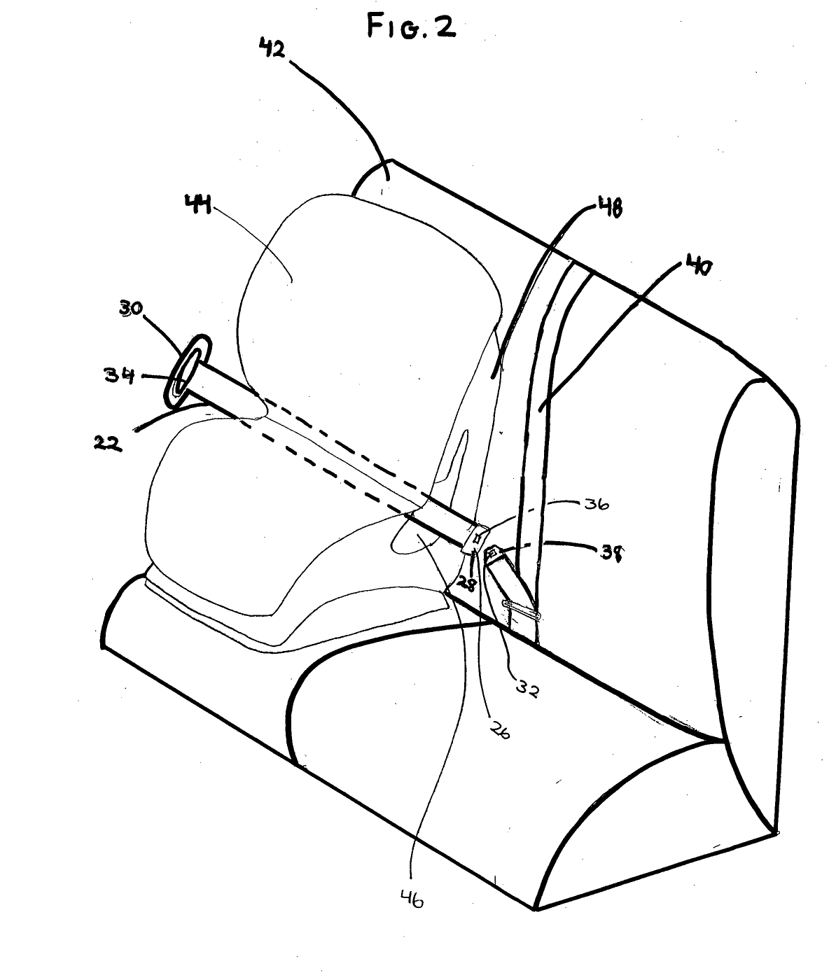

Turning now to FIG. 2, seatbelt guide 20 is shown in use. Seat 42 of a vehicle is shown having a standard seatbelt 40. Seatbelt 40 has a tab end 38 and a buckle end (not shown). When a car seat 44 is placed onto seat 42 it must be secured using seatbelt 40. Typically, car seat 44 has two slots 46 in the rear 48 of the car seat. To secure car seat 44 to seat 42, seatbelt 40 must be threaded through slots 46 and fastened to the buckle end of seatbelt 40.

Seatbelt guide 20 is guided through slots 46 by a user. Once seatbelt guide 20 is through both slots 46, engagement end 26 engages tab end 38 of seatbelt 40. Seatbelt 40 is now secured to seatbelt guide 20. Seatbelt guide 20 can then be pulled through slots 46 towards the user, thereby threading seatbelt 40 through the slots.

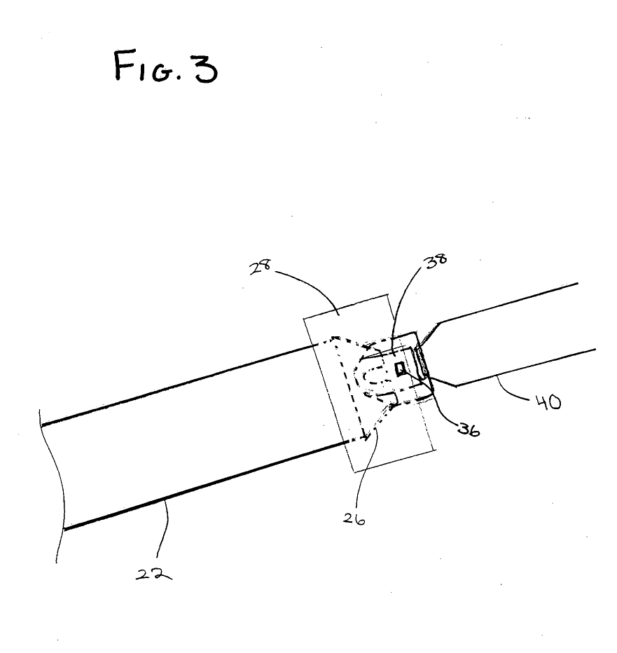

Referring now to FIG. 3, seatbelt 40 is engaged by buckle 28 making a secure connection. Referring back to FIG. 2, once seatbelt 40 is secured to seatbelt guide 20, the user pulls the seatbelt guide and seatbelt 40 through slots 46. When seatbelt 40 is completely through slots 46, the user can press button 36 and release the seatbelt. Seatbelt 40 can then be secured to the buckle end of the seatbelt. Car seat 44 is now properly secured to seat 42.

The present application offers advantages over traditional car seats. There is no need to slip a user's hand through the back of a car seat. The seatbelt guide allows the user to simply push the device through the slots of a car seat and fasten it to the seatbelt on the other end.

Although the invention has been described and illustrated with respect to exemplary embodiments thereof, it should be understood by those skilled in the art that the foregoing and various other changes, omissions and additions may be made therein and thereto, without parting from the spirit and scope of the disclosed subject matter.

What is claimed is:

1. A seatbelt guide for use in a child's car seat comprising:
a handle end and an opposing engagement end with an extending length portion disposed between said handle end and said engagement end,
said engagement end being effective to grasp a tab end of a seatbelt, wherein said extending length portion is sized to be threaded through slots of a child's car seat.

2. A seatbelt guide according to claim 1, wherein said engagement end is a buckle end of a seatbelt.

3. A seatbelt guide according to claim 2, wherein said seatbelt guide is made from plastic.

4. A seatbelt guide according to claim 3, wherein said handle end has a grip adapted to be held by a user.

5. A seatbelt guide according to claim 4, wherein said seatbelt guide has a length effective to reach behind a car seat and grasp a seatbelt.

6. A seatbelt guide according to claim 5, wherein said seatbelt guide has a width and thickness effective to slide between slots of a child's car seat.

7. A seatbelt guide according to claim 5, wherein said length is about 22 to 26 inches.

8. A seatbelt guide according to claim 6, wherein said width is about 1 to 3 inches, and said thickness is about 0.25 to 0.5 inches.

9. A method for fastening a child's car seat into a car having a standard seatbelt with a tab end and a buckle end, comprising the steps of:
providing a seatbelt guide having an engagement end;
pushing said seatbelt guide through seatbelt slots in the rear of said car seat;
engaging said engagement end of said seatbelt guide with said tab end of said seatbelt;
pulling said seatbelt guide through said seatbelt slots thereby threading said seatbelt through said seatbelt slots;
releasing said engagement end of said seatbelt guide from said tab end of said seatbelt; and
attaching said tab end of said seatbelt with said buckle end of said seatbelt that is installed in a vehicle.
